(19) United States
(12) Patent Application Publication
(10) Pub. No.: US 2005/0213549 A1
(43) Pub. Date: Sep. 29, 2005

(54) System and method for access point/probe conversion

(76) Inventors: Laura Bridge, Sharon, NH (US); Paul D. Callahan, Carlisle, MA (US); Michael Yuen, Waltham, MA (US)

Correspondence Address: STEUBING AND MCGUINESS & MANARAS LLP, 125 NAGOG PARK, ACTON, MA, 01720, US

(21) Appl. No.: 10/810,083

(22) Filed: Mar. 26, 2004

(51) Int. Cl. H04H 1/00

(52) U.S. Cl. 370/338

(57) ABSTRACT

A system and method is provided for converting an Access Point (AP) in a wireless network into a Probe device for performing probe operations. WLAN managers may thus temporarily direct certain APs in the WLAN to instead behave as Probes. Communication between the AP and the stations is re-directed to one or more other APs in the WLAN either before or after the AP transitions into a Probe device. When a system manager determines that enough Probe data has been collected, the Probe device may be transitioned back into an AP. With such an arrangement, a system manager can control the placement and operation of Probes in the WLAN, without the added expense or manual intervention required in providing dedicated Probe devices.

### FIELD OF THE INVENTION

This invention relates generally to the field of communication and more particularly to the field of network monitoring.

### BACKGROUND OF THE INVENTION

As it is known in the art, a Wireless Local Area Network (WLAN) is a local-area network that uses high-frequency radio waves, rather than wires, to communicate between nodes. Typically, one of the devices in the wireless network serves as an Access Point (AP), serving as a communication hub for users of a wireless device (or station) to connect to a wired LAN. Software, executing at a station, selects the best Access Point available for connection to the LAN, taking into consideration various characteristics (such as signal power level and loading) of each AP connection.

Sometimes it may occur that an unauthorized or ‘rogue’ AP may be inserted into an existing wireless network. The rogue AP draws traffic away from the valid AP, thus potentially affecting the quality of service provided to the wireless stations. The rogue AP may have been inserted by a malicious user to adversely affect the operation of the WLAN, or alternatively been added to the network by a well meaning, yet unauthorized individual. In either instance, it is important that the WLAN manager have the ability to monitor the WLAN for the existence of the rogue APs.

One device which is typically used to detect rogue devices is a WLAN Probe. The Probe is also used to monitor various parameters of the WLAN in order to understand the performance of the WLAN, diagnose problems or detect other sources of interference. Probe devices typically include software that enables it to monitor, or “scan” all channels to collect the desired network statistics. Probe devices thus differ from AP devices, which must always stay on the same channel as the stations which are associated to it, so that the AP does not “miss” any packets that may be sent by stations on their channels.

Currently, WLAN managers add WLAN probes to their network in any location where a Probe may be needed (usually at the physical perimeter). In other embodiments, a single probe is physically periodically moved around the network in order to make measurements in all the places where they wish to take such measurements. These probe placement options therefore either add expense (if many Probes are deployed) or manual intervention (if a single Probe must be physically moved around) to the WLAN, neither of which is desirable.

### SUMMARY OF THE INVENTION

According to one aspect of the invention, a system and method is provided for converting an Access Point (AP) in a wireless network into a Probe device for performing probe operations. WLAN managers may thus temporarily direct certain APs in the WLAN to instead behave as Probes. Communication between the AP and the stations is re-directed to one or more other APs in the WLAN either before or after the AP transitions into a Probe device. When a system manager determines that enough Probe data has been collected, the Probe device may be transitioned back into an AP. With such an arrangement, a system manager can control the placement and operation of Probes in the WLAN, without the added expense or manual intervention required in providing dedicated Probe devices.

According to one aspect of the invention, a method for monitoring a wireless network comprised of a plurality of access points coupled to a plurality of stations, the method comprising the steps of converting a selected access point into a probe device, performing probe operations by the probe device, and forwarding information retrieved from the probe operations to a management device.

According to another aspect of the invention, a device includes means for operating as an access device to permit a plurality of wirelessly coupled devices to communicate with a wired network, the access device and the plurality of wirelessly coupled devices forming a wireless network, means for operating as a probe device for scanning the plurality of wirelessly coupled devices to obtain operating statistics for the wireless network; and means for selectively operating as either the access device or the probe device in response to receipt of a command at the device.

### BRIEF DESCRIPTION OF THE DRAWINGS

FIG. 1 shows a wireless communications environment in which wireless users interact with other networked devices via an access point (AP);

FIG. 2 is a flow diagram illustrating an exemplary method that may be used to convert and Access Point to a Probe device, and back again;

FIG. 3 illustrates a wireless network wherein one of the APs has been converted to a Probe device, and other stations are re-directed to the remaining AP device;

FIG. 4 illustrates a method for converting a Probe device to an AP device; and

FIG. 5 illustrates a method for selecting a channel for the AP following the Probe.

### DETAILED DESCRIPTION

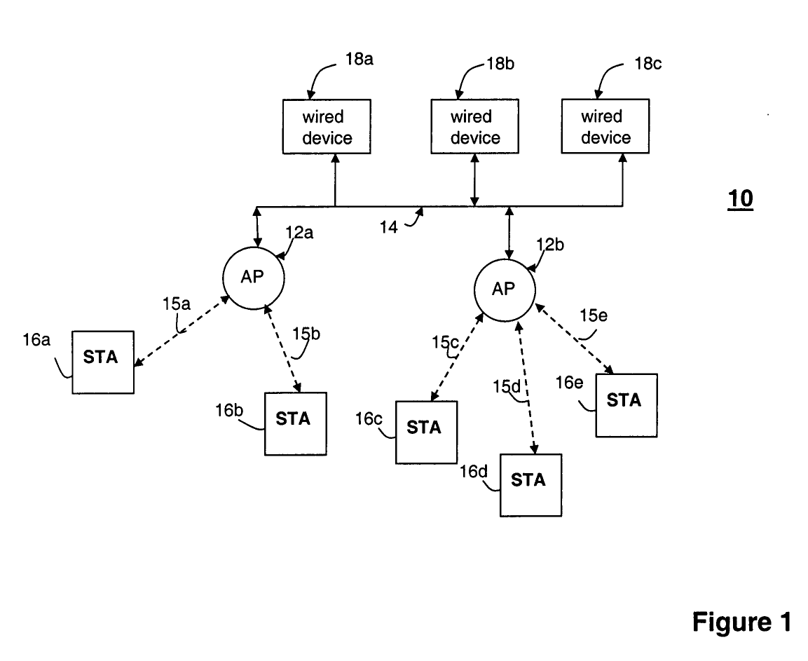

In accordance with the present invention, a system and method for converting an Access Point (AP) device into a Probe device in a Wireless Local Area Network (WLAN) will now be described with reference to the attached figures. Referring to FIG. 1, a typical wireless communications environment 10 includes access devices 12a and 12b that interface between a wired communications medium 14 and wireless devices 16a-16e to provide network access to the wireless devices 16a-16e. Wireless device 16a and 16b can thus communicate with wired devices 18 and with each other via the access device 12a, and wireless devices 16c, 16d and 16e can communicate with wired devices 18 and with each other via access device 12b. These access devices 12a and 12b are referred to by various names depending upon the wireless architecture employed, and are herein referred to as “access points” or “APs”. The wireless devices 16a-16e also have various architecture dependent names and are herein referred to as “stations” or STAs. A wireless communications capable device may be an AP, or a STA, or both.

Various types of wireless communications environments 10 exist. Wireless communications environments include for example wireless data networks and wireless I/O channels. An example of a wireless data network is described in “IEEE Standard for Information technology—Telecommunications and information exchange between systems—Local and metropolitan area networks—Specific requirements—Part 11: Wireless LAN Medium Access Control (MAC) and Physical Layer (PHY) specifications—Amendment 1: High-speed Physical Layer in the 5 GHz band”, incorporated herein by reference (hereinafter “802.11”). Furthermore, various different 802.11 “modes” are defined. For example, in IEEE 802.11 compatible wireless networks, wireless devices may be arranged in an “infrastructure mode”, whereby the network is configured such that STAs 16a-16e communicate with other network devices via APs 12a and 12b, as shown in FIG. 1. 802.11 compatible devices may also be arranged in “ad-hoc” mode, whereby all the STAs 16a-16e are within transmission range and can communicate directly with each other. Furthermore, wireless “mesh” technologies exist, whereby each wireless device acts as both an AP and a STA. Wireless I/O channels can be used to provide I/O communications, for example, between servers and storage devices via the “Bluetooth” Standard, or between home entertainment audio and video components, or between wireless telephone handsets and base stations. The various aspects of the invention apply generally to wireless networking architectures, including those used in wide area networks, metropolitan area networks, enterprise networks, and home networks, and wireless I/O channel architectures, as they exist now and as they are developed.

One network in which the present invention may be employed is the Wireless Local Area Network described in pending U.S. Application Ser. No. 10,781,228, attorney docket number 160-011 entitled “Transmission Channel Selection Apparatus”, filed Feb. 18, 2004, by Backes et al, (hereinafter the Backes application) and incorporated herein by reference.

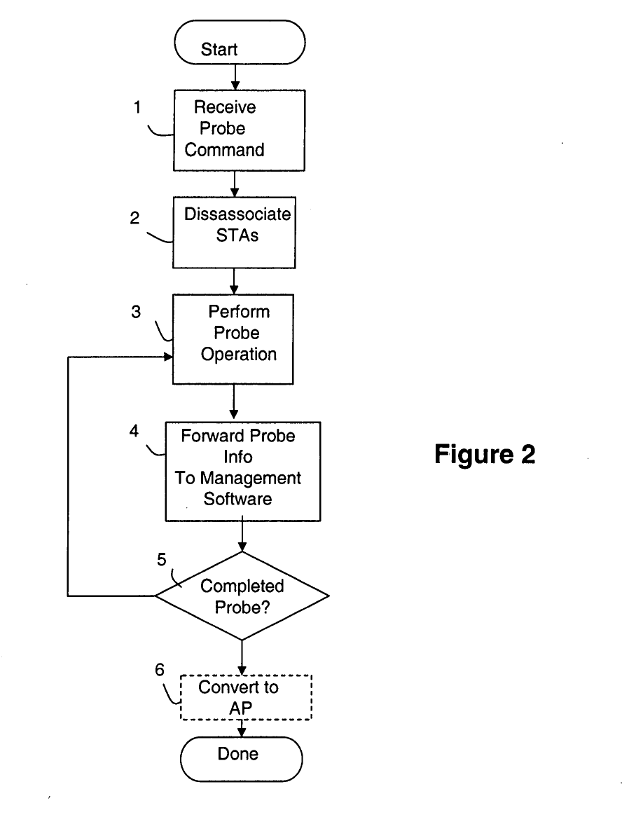

The present invention provides a system and method for converting one of the access points (12a or 12b) into a Probe type device for the purpose of performing Probe operations. Referring now to FIG. 2, a flow diagram illustrating exemplary steps that may be taken to covert an AP device to a Probe device, and back again, will now be described. For the purpose of this specification, a Probe operation is any performance monitoring or data collection operation that may be performed for the purpose of analyzing network performance. According to one embodiment of the invention, an Access Point may ‘convert’ its functionality from access point functionality to probe device functionality by entering an operative state referred to hereinafter as Probe mode. A variety of external events may occur that cause an access device to transition to Probe mode state, including receipt of a Probe command at a local command line interface and receipt of a Probe command from a coupled network management device. The user or network manager could transition an AP to a Probe for a variety of reasons, including for the purpose of gathering data to analyze operation at a particular point of the network, and also to assist in the location of rogue APs. For example, should a network manager detect the possible presence of a rogue AP, the manager can, using the concepts of the present invention, convert an AP device that is proximate to the rogue AP into a Probe device, for the purpose of monitoring communication from the rogue AP.

According to another aspect of the invention, conversion between AP and Probe functionality at a device may be software controlled to occur automatically. In such instances, the network manager may program a system to periodically cycle through the WLAN, converting APs to Probe devices for the purpose of collecting a complete picture of the operating characteristics of the WLAN. Thus it can be seen that the present invention provides a mechanism by which a WLAN may be monitored for performance and security purposes without dedicated Probe devices or other types of manual intervention.

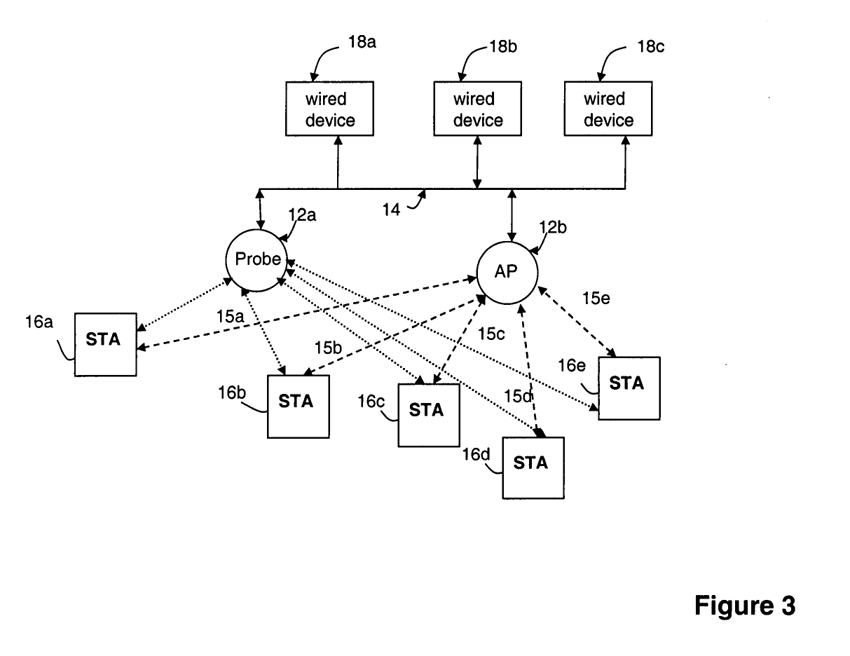

Whichever method is used to cause the conversion to happen, in FIG. 2, at step 1 the AP device receives the Probe command, and begins the conversion process. At step 2, all STAs that are associated with the AP are disassociated to free up the AP for Probe operation. Referring briefly to FIG. 3, when an AP is transitioned to a Probe Mode operative state, the STAs that are coupled to the AP need to be re-routed to another AP in the WLAN. Thus, in FIG. 3, STAs 16a and 16b are re-routed for handling by AP 12b. The re-routing of the STAs to the APs can be performed in a variety of manners, all of which are encompassed within the present invention. For example, in one embodiment, the transition is controlled by the issuance of a RESET command to the AP. The RESET command instructs the AP to disassociate all of the coupled STAs. The AP may disassociate the coupled STAs directly by command, telling the STA to find another AP, or passively, by merely failing to respond to communication from the coupled STAs. Thus, in the example of FIG. 2, AP 12a disassociates STAs 16a and 16b, which subsequently connect to the closest AP 12b.

Referring back to FIG. 2, once the STAs have been disassociated, at step 3 the Probe operation is initiated. As mentioned above, the Probe operation may be any type of network monitoring operation, and thus the present invention is not limited to any particular operation being performed as part of the Probe. However, by way of example, in one embodiment, upon entering Probe Mode, Probe device performs a scan of all channels, and captures all the Beacon's that are received, by recording the address, channel and signal strength, or other data from the Beaconing device in a table. In this description, a ‘Beacon’ is a broadcast management packet sent by an AP to other APs and STAs in the WLAN. Thus the table compiles a list of all Beaconing devices, providing a complete picture of the transmitting devices in an WLAN operating environment. At step 4 the table is forwarded to the network management software, which may analyze the table to identify rogue APs, APs which are having performance issues, etc. At step 5, the process determines whether Probe mode is to be exited. A Probe may remain in Probe mode for any amount of time, and thus the duration that an AP remains a Probe is not a limitation of the present invention. In fact, a variety of Probe conversion durations are envisioned by this invention, including having the AP remain in Probe mode for a single scan, a preselected scan period, or until a problem with the system has been identified. In an embodiment wherein WLAN APs are sequentially converted to Probes, the duration of time may be such that each AP is a Probe for some slice of a monitoring period. Alternatively, when an AP device may function as a Probe for the entire time that the network is connected. The present invention thus provides a flexible method for Probe placement in a WLAN environment.

When it is determined at step 5 that the Probe operation for the device is completed, optional step 6 may be performed to convert the Probe device back into an Access Point. Note that the performance of this step is not a requirement of the invention, as a user may choose to convert and AP to a permanent Probe, and thus not require that the Probe be re-converted. Because the step is optional, it is showed as dashed box 6 in FIG. 2. At step 6 the Probe optionally initializes to an AP using standard AP initialization processes such as those described in the pending Backes application, incorporated by reference above.

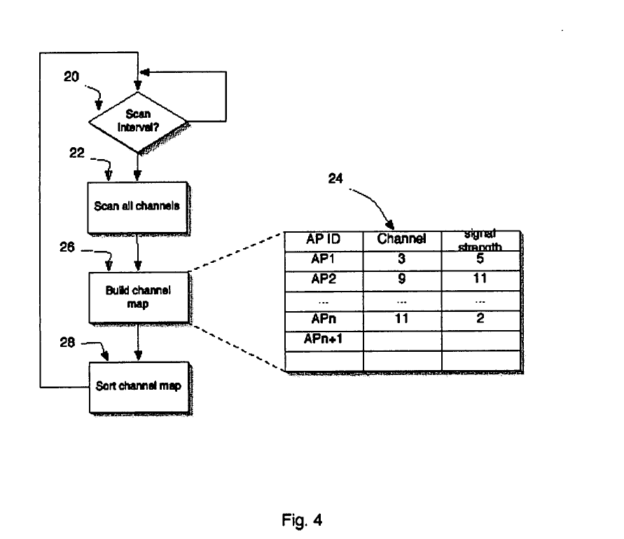

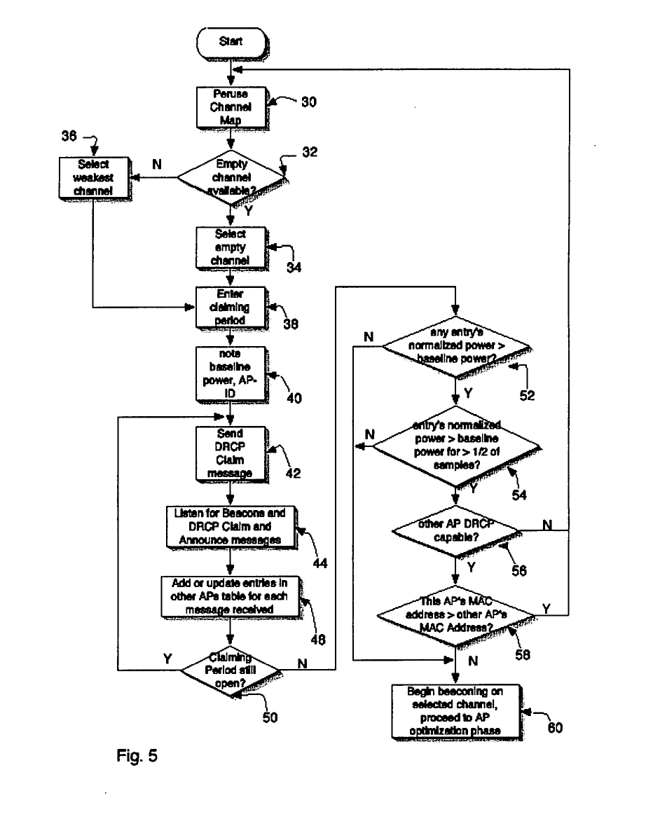

For purposes of clarity, the steps performed in converting a Probe device into an AP device will now be described with reference to FIGS. 4 and 5. Note that these steps are basically a standard AP initialization process described in the Backes application. During AP initialization, APs either perform automatic channel selection to identify a channel for transmission, or alternatively ‘remember’ the channel that the AP used for previous transmission. In accordance with the channel selection aspect of the invention, APs located in the same wireless network automatically select channels for operation such that they do not interfere with nearby APs. The invention contemplates that different bands of frequencies are available, for example based on 802.11 version and the country in which the network is deployed. According to a preferred embodiment, APs attempt to select a channel, in each band in which the AP is equipped to operate, which is least likely to interfere with other APs that are already deployed. APs also quarantine channels in accordance with rules associated with regulatory domains (Europe, etc.) so they don't interfere with other wireless applications (radar, etc.). In the event that one AP selects a free channel, and another AP selects the same free channel at the same time (i.e. a channel selection “Collision”), the APs' media access control (MAC) addresses are used as a tie breaker. If the other AP is a standard AP that does not include the improvements associated with the current invention, then the invention-enabled AP will direct its own radio to the “next best” channel. The AP repeats the channel selection phase for each band of frequencies.

More particularly, referring to FIG. 4, before a newly added AP 12 starts to “Beacon” (i.e. broadcast management packets to other APs and STAs), the AP 12 first examines a list of RF bands supported by the AP 12, and the list of channels supported and not quarantined by the radio which implements the Physical Layer (PHY) for each RF band. The AP 12 then selects a channel in each band according to the following algorithm:

For each band, scan Intervals occur periodically. During a Scan Interval (step 20), the AP 12a passively scans all channels which the AP supports within the band (step 22). The AP 12a gathers a list of active APs 12a, the channels on which they are operating, and the power at which the beacons from each AP 12 was heard. This information is used to build a table called a channel map 24 (step 26), which contains a list of all APs 12a heard from, the channel on which they were heard, and the signal strength at which they were heard. There is a separate channel map 24 for each band. The AP 12a sorts the channel map to produce a list of APs 12 in ascending order of power level (step 28).

Referring to FIG. 5, a channel is now selected by the AP 12 as follows. First, the AP 12a peruses the channel map (step 30), and if there is a channel on which no AP 12a is operating (i.e. signal strength=0) (step 32), then the AP 12 selects that channel (step 34). Otherwise, the AP 12a peruses the list for the channel transmitting the weakest signal (step 36). The AP 12a now enters a time interval referred to as the “claiming period” (step 38).

If the AP 12a selected a channel having the weakest signal strength, the APa 12 notes the channel-ID of the channel that it has selected, the received power level on the channel, and the AP-ID of the AP that generated that power level (step 40). It will use the power level value as a baseline against which to detect increases in received power on its selected channel. If the AP 12a selected an empty channel, the baseline power level will be the AP's noise floor.

The AP 12a then advertises its intention to use the selected channel by periodically transmitting Dynamic Radio Controlled Protocol Claim messages (described in the Backes application) during the claiming period (step 42). Claim messages are transmitted at full power to ‘claim’ the channel. During this claiming period, the AP 12 receives all Beacons, DRCP Claim messages, and DRCP Announce messages transmitted on the currently chosen channel (step 44) and uses the information contained therein to build an “Other APs” table 46 (FIG. 6, FIG. 5 step 48). For each Beacon it receives, the AP 12 notes the AP-ID and the received power level in the Other APs table 46. For each Claim or Announce message it receives, the AP 12 notes the AP-ID of the AP that sent the message, the received power level, and the transmit power backoff (TP backoff) in the Other APs table 46. The TP Backoff value indicates how far from maximum power the sending AP's radio has been turned down, and will be explained in more detail in the AP Power Adjustment section. The AP 12 also marks the entry for that AP-ID as being DRCP capable. A normalized received power value is calculated by adding the TP Backoff value to the received power value. The normalized received power value equalizes the AP power levels for comparison purposes. When the AP 12 receives a Beacon or DRCP message from an AP for which it already has an entry, it updates the entry and stores the received power and TP_backoff values as a list.

If another AP 12 starts to radiate significant energy on the selected channel, one of two events must have occurred. The new AP 12 is either not running DRCP, or a conflict has occurred with another DRCP-active AP, where a race condition has caused the other DRCP-active AP to select the same channel at the same time. This is called a Channel Selection Collision (CSC).

At the end of the claim period (step 50), the AP 12 stops sending Claim messages and evaluates the information it has collected, its CSC data, to determine if a CSC has occurred. It looks to see if the received power in any entry is greater than the baseline power level it recorded for the channel (step 52). If so, it looks to see if the received power is exceeded in at least half of the power level values for the entry (step 54). If so, the AP 12 checks to see whether the AP in the entry is DRCP capable (step 56).

If the other AP is not DRCP active, the AP 12 defers to the non-DRCP-active AP and starts the entire channel selection process over again.

If the other AP is DRCP-active, then a CSC is assumed to have occurred. When a CSC has occurred, the MAC address of the other AP is compared to the MAC Address of this AP 12. If the MAC address of this AP 12 is numerically higher than the observed MAC address (step 58), this AP 12 starts the channel selection process over again.

If at the end of the claiming period, the AP has succeeded in claiming the selected channel, it begins running on the channel. The AP starts beaconing, begins sending DRCP Announce messages, and prepares to enter the Optimization stage in order to run its Auction and Power Adjustment functions (step 60).

It should be noted that although the above embodiments have been described as though the AP was a single radio device, different AP devices include functionality to support a range of radio devices transmitting on frequencies and using protocols of the 802.11a, 802.11b, 802.11g WLAN standards. When using the present invention on an AP device that supports multiple RF ranges, it should be noted that the entire AP device need not be transitioned to a Probe device. Rather, the present invention may be modified to include commands such as ‘Probe A’, indicating that an AP device should modify its operation to serve as a Probe Device for 802.11a channels, and as AP devices for any other channels that it supports. Other commands may also be provided, such as ‘Probe All’ indicating all channels should be modified to Probes, ‘Probe B’ or ‘Probe G’, for converting AP 802.11b and 802.11g channel devices, respectively, into Probe devices for the respective channels.

Accordingly a method and system for temporary or permanent conversion of an AP device into Probe device has been shown and described. The conversion may occur as a result of an external command issued by a third party, or alternatively automatically. The automatic conversion may occur due to routine monitoring of the WLAN, or alternatively upon detection of performance or security issues in the network. Converting existing APs into Probe devices is superior to deploying dedicated Probes in the network, because to cover all of the areas within reach of the APs would require a lot of Probes, or otherwise a single Probe would have to be moved manually to various parts of the network in turn to achieve the same coverage. The present invention overcomes these obstacles to provide an economical and easy to implement network monitoring solution.

Having described an exemplary embodiment of the present invention, it will be appreciated that various modifications may be made without diverging from the spirit and scope of the invention. For example, FIG. 2 is a flowchart illustration of methods, apparatus (systems) and computer program products according to an embodiment of the invention. It will be understood that each block of the flowchart illustrations, and combinations of blocks in the flowchart illustrations, can be implemented by computer program instructions. These computer program instructions may be loaded onto a computer or other programmable data processing apparatus to produce a machine, such that the instructions which execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative program command structures, one skilled in the art will recognize that the system may be embodied using a variety of specific command structures. Accordingly, the invention should not be viewed as limited except by the scope and spirit of the appended claims.

1. A method for monitoring a wireless network comprised of a plurality of access points coupled to a plurality of stations, the method comprising the steps of:
converting a selected access point into a probe device;
performing probe operations by the probe device; and
forwarding information retrieved from the probe operations to a management device.

2. The method of claim 1, wherein the step of converting the selected access point includes the step of forwarding a Probe command to the selected access point.

3. The method of claim 1, wherein the step of converting the selected access point into a probe device includes the steps of disassociating stations coupled to the selected access point from the selected access point.

4. The method of claim 3, wherein the step of disassociating stations includes the step of forwarding a Reset command to each station coupled to the selected access point.

5. The method of claim 3, wherein the step of disassociating stations includes the step of failing to respond to communications from each station coupled to the selected access point.

6. The method of claim 1, wherein the selected access point is selected in response to its proximity to an unauthorized access point.

7. The method of claim 1 wherein the selected access point is automatically selected in response to the detection of a network problem.

8. The method of claim 1, wherein the selected access point is automatically selected in response to a periodic scan of each of the plurality of access points in the network.

9. The method of claim 1, further comprising the step of converting the probe device into an access point after forwarding information to the management device.

10. The method of claim 1, wherein the selected access point includes a plurality of radio frequency channels, and wherein the selected access point continues to serve as an access point for a first subset of the plurality of channels and serve as a probe device for a second subset of the plurality of channels.

11. A device comprising:
means for operating as an access device to permit a plurality of wirelessly coupled devices to communicate with a wired network, the access device and the plurality of wirelessly coupled devices forming a wireless network;
means for operating as a probe device for scanning the plurality of wirelessly coupled devices to obtain operating statistics for the wireless network; and
means for selectively operating as either the access device or the probe device in response to receipt of a command at the device.

12. The device of claim 11, wherein the command is a Probe command forwarded by a network manager to the device.

13. The device of claim 11, wherein the command is a Probe command received a command line interface on the device.

14. The device of claim 11, wherein the Probe command is automatically generated by the device in response to an event.

15. The device of claim 14, wherein the event is the detection of an unauthorized access point in the network.

16. The device of claim 14, wherein the event is the detection of network performance degradation in the wireless network.

17. The device of claim 14, wherein the means for operating as an access point operates over a range or channels, and wherein the means for operating as a probe device operates over the range of channels, and wherein the device operates as an access device over a first subset of the range of channels and operates as a probe device over a second subset of the range of channels.
